(19) United States
(12) Patent Application Publication
(10) Pub. No.: US 2014/0096117 A1
(43) Pub. Date: Apr. 3, 2014

(54) DATA DEPENDENCE ANALYSIS SUPPORT DEVICE, DATA DEPENDENCE ANALYSIS SUPPORT PROGRAM, AND DATA DEPENDENCE ANALYSIS SUPPORT METHOD

(71) Applicant: Panasonic Corporation, Osaka (JP)

(72) Inventor: Akira Tanaka, Osaka (JP)

(73) Assignee: PANASONIC CORPORATION, Osaka (JP)

(21) Appl. No.: 13/813,836

(22) PCT Filed: Sep. 28, 2012
(86) PCT No.: PCT/JP2012/006223

§ 371 Date: Feb. 1, 2013

(30) Foreign Application Priority Data
Jan. 13, 2012 (JP) 2012-005449

(51) Int. Cl. G06F 9/45

(52) U.S. Cl. CPC G06F 8/434
USPC 717/149

(57) ABSTRACT

A data dependence analysis support device calculates pointer information by performing a context-sensitive pointer analysis on every pointer used in a program; calculates dataflow information between statements by performing a context-sensitive dataflow analysis, using the context-sensitive pointer information, on all statements in an analysis target region and all statements that might be called upon execution of the analysis target region; and calculates inter-region data dependence information, using the dataflow information, for two or more threaded regions included in the source program.

### TECHNICAL FIELD

The present invention relates to program development technology for implementing a parallel processing system, and in particular relates to technology for analyzing data dependence of a source program.

### BACKGROUND ART

In recent years, demand is unrelenting for an increase in performance in processors found within consumer devices, such as digital televisions, Blu-Ray recorders, cellular telephones, and the like, due to reasons such as an increase in the quantity and quality of multimedia processing, an increase in communication speed, and an increase in the amount of interface processing, for example in gaming devices.

As a result of recent progress in semiconductor technology, processors with a multiprocessor structure that can process threads in parallel, as well as single processors that can process a plurality of threads in parallel, are now incorporated in consumer devices.

Nevertheless, a library of sequential programs that presuppose execution by a single processor have accumulated over time. In particular, a tremendous number of sequential programs have been written in the C and C++ languages. To take advantage of this library of sequential programs, there is a desire to accelerate these programs by parallelization.

In the case of new programs, both development and verification of parallel-threaded programs is more difficult than for sequential programs. Therefore, instead of developing parallel-threaded programs directly, a typical method of development is to develop and verify a sequential program and then to convert the sequential program into parallel threads.

The program processing device in Patent Literature 1 discloses a conventional example of thread parallelization of the sequential program. The program processing device in Patent Literature 1 receives, as a parallel processing program, a designation of threaded regions within the source code of the sequential program. The designation is received using a THREAD designator. The program processing device of Patent Literature 1 parallelizes the threads by first analyzing dependence between the threaded regions. For variables for which data is delivered from one thread to another, the program processing device then inserts inter-thread communication code for the delivery of data into each thread after parallelization.

### CITATION LIST

### Patent Literature

### [Patent Literature 1]

Japanese Patent Application Publication No. 2007-193423

### Non-Patent Literature

### [Non-Patent Literature 1]

Alfred V. Aho, et al, “Compilers: Principles, Techniques & Tools Second Edition”, Addison Wesley, 2007

### SUMMARY OF INVENTION

### Technical Problem

With the technology in Patent Literature 1, however, code which is not found in the sequential program, i.e. the inter-thread communication code for the delivery of data, is inserted into each thread after parallelization. This communication code represents new overhead. In particular, when the accuracy of data dependence analysis is low, causing unnecessary communication code to be inserted, the problem of a decrease in the speed of the parallel program occurs.

Another problem is that an extremely long time is typically required to perform highly accurate data dependence analysis.

It is an object of the present invention to provide a data dependence analysis support device that can analyze data dependence between threaded regions accurately and in a short time.

### Solution to Problem

In order to solve the above problems, a data dependence analysis support device according to the present invention is for performing a context-sensitive data dependence analysis on a source program, and comprises: a pointer information generation unit configured to generate pointer information by performing a context-sensitive pointer analysis on every pointer used in the source program; a dataflow information generation unit configured to generate dataflow information by performing a context-sensitive dataflow analysis, using the pointer information, on an analysis target region that is a portion of the source program and is designated for analysis of data dependence between two or more threaded regions; and an inter-region dependence information generation unit configured to generate inter-region dependence information on data dependence between the two or more threaded regions using the dataflow information, the inter-region dependence information indicating a threaded region that is a source of dependence, a threaded region that is a target of dependence, and a variable causing dependence.

### Advantageous Effects of Invention

With the above structure, the data dependence analysis support device shortens the analysis time by performing dataflow analysis, which is a portion of processing for data dependence analysis, not over the entire source program but rather only on the analysis target region. The data dependence analysis support device can also acquire highly accurate information on dependence between threaded regions by performing a context-sensitive analysis during pointer analysis and dataflow analysis, which are a portion of processing for data dependence analysis, thereby making a highly accurate analysis compatible with a reduction in analysis time.

### BRIEF DESCRIPTION OF DRAWINGS

FIG. 1 is a block diagram illustrating the structure of a data dependence analysis support device 100 according to an embodiment.

FIG. 2 is a block diagram illustrating the structure of a dataflow analysis unit 206 and a dataflow information storage unit 207 according to the embodiment.

FIGS. 3A, 3B, and 3C illustrate an example of a source program 11 according to the embodiment.

FIG. 4 illustrates an example of a call graph stored in a call graph storage unit 203 according to the embodiment.

FIG. 5 is a flowchart illustrating operations of the data dependence analysis support device 100 according to the embodiment.

FIG. 6 is a flowchart illustrating operations of a pointer information combination unit 220 according to the embodiment.

FIG. 7 is a flowchart illustrating operations of an inter-region dependence generation unit 210 according to the embodiment.

FIG. 8 illustrates an example of statement information stored in an intermediate program storage unit 201 according to the embodiment.

FIG. 9 illustrates an example of pointer information stored in a pointer information storage unit 205 according to the embodiment.

FIG. 10 illustrates an example of pointer information stored in a combined pointer information storage unit 221 according to the embodiment.

FIG. 11 illustrates an example of assignment information stored in an assignment information storage unit 223 according to the embodiment.

FIG. 12 illustrates an example of usage information stored in a usage information storage unit 225 according to the embodiment.

FIG. 13 illustrates an example of reachable assignment information stored in a reachable assignment information storage unit 227 according to the embodiment.

FIG. 14 illustrates an example of inter-statement dependence information stored in an inter-statement dependence information storage unit 209 according to the embodiment.

FIG. 15 illustrates an example of inter-region dependence information stored in an inter-region dependence information storage unit 211 according to the embodiment.

FIG. 16A, FIG. 16B, and FIG. 16C illustrate examples of system end information, analysis target region information, and region designation information, which are user input information 41 according to the embodiment.

FIGS. 17A and 17B illustrate examples of region designation by text and by mouse according to the embodiment.

FIGS. 18A, 18B, and 18C illustrate an example of inter-region dependence display, by text and on the source program 11, according to the embodiment.

FIGS. 19A and 19B illustrate an example of thread parallelization according to the embodiment.

FIG. 20 illustrates an example of inter-region designation listed in a source program 11 according to the embodiment.

### DESCRIPTION OF EMBODIMENTS

### Outline of the Present Invention

In order to develop a parallel-threaded program that uses a sequential program as a source program, it is necessary to analyze data dependence in a region of the sequential program that is to be converted into parallel threads. In particular, during parallelization to resolve data dependence by inter-thread communication code (pipelining), it is preferable to perform highly accurate analysis of dependence so that no unnecessary communication code is inserted.

A context-sensitive analysis, however, also needs to analyze the function called by each function call. As a result, a long amount of time is required as compared to an analysis that is context insensitive, which only analyzes a function once. In particular, an extremely long time is required to perform a context-sensitive analysis of the entire program.

In the case of a sequential program written in the C or C++ languages, the procedure for data dependence analysis includes pointer analysis and dataflow analysis. Pointer analysis analyzes the variables pointed to by pointers. Dataflow analysis analyzes how variables are assigned and referenced, and when a variable is referenced, also analyzes the statement in which the value of the variable is assigned.

Pointer analysis needs to be performed for the entire source program. This is because if it is unclear which variable is pointed to by a pointer, then the variable that is assigned or used by dereferencing the pointer cannot be determined, thereby preventing a highly accurate analysis of data dependence.

With regards to dataflow analysis, the inventors discovered that if pointer analysis is performed for the entire source code, then dataflow analysis need only be performed for the portion of the source program that is the target of data dependence analysis. This is because all of the information that is necessary for analyzing data dependence in a region is normally included in the region that is being focused on (if the region is a portion of a control structure such as a loop or a branch, then the entire control structure) and a called region consisting of a collection of statements that are called by this region (hereinafter, both the region being focused on and the called region are referred to collectively as an analysis target region). The only unclear factor is the relationship between pointers and variables. In other words, if the variables pointed to by pointers are clear, it is possible to analyze data dependence by performing dataflow analysis on the analysis target region.

Note that the analysis time for a context-sensitive pointer analysis depends on the total number of pointers, whereas the analysis time for a context-sensitive dataflow analysis depends on the total number of statements. In general, the number of statements in a program is much larger than the number of pointers. When analyzing the same entire source program, the analysis time for a context-sensitive dataflow analysis is approximately 10 times longer than for a context-sensitive pointer analysis.

While a context-sensitive pointer analysis needs to be performed over the entire source program, the present invention focuses on how dependence can be analyzed between threaded regions by performing a context-sensitive dataflow analysis only over an analysis target region that includes all of the threaded regions. Thus limiting the target of the dataflow analysis, which occupies the majority of the analysis time, allows for both a highly accurate context-sensitive analysis and a reduction in analysis time. The following describes the procedure for parallelization and differences in accuracy for different analysis methods.

### Procedure for Parallelization of a Sequential Program

The following describes a general procedure for analysis of data dependence in a sequential program and thread parallelization. In the case of a sequential program written in C or C++, an analysis device that performs an analysis of data dependence between threaded regions performs the following procedure.

First, the analysis device performs a pointer analysis to analyze which variables are pointed to by pointers.

Next, the analysis device uses the results of the pointer analysis to perform a dataflow analysis that analyzes the statements in which the values of variables are updated and the statements in which the values of variables are referenced. In this context, a “statement” is a basic unit within the structure of a program. In C or C++, a statement ends in a semicolon.

To simplify the following explanation, the “value stored by a variable” is referred to as the “value of a variable”, “updating of the value stored by a variable” is referred to as “assignment of a variable”, and “referencing the value stored by a variable” is referred to as “using a variable”. In this context, “updating” includes assigning a new value to a variable that has not yet been initialized.

Next, based on the dataflow analysis the analysis device performs an analysis of data dependence between each statement. Data dependence refers to the relationship when a variable x is assigned a value in one statement, and then the variable x is used in another statement.

Next, the analysis device analyzes data dependence between regions to identify variables for which data is delivered between threaded regions. The analysis device then inserts communication code into the threads so that the values held by the variables for which data is delivered between threaded regions can be passed between regions.

What is important is that increasing the accuracy of the data dependence analysis contributes to increasing the speed of a parallel-threaded program. If thread parallelization is performed without inserting communication code despite data dependence between threaded regions, then when a statement that is the target of dependence is located in a different thread from the statement that is the source of dependence, a problem occurs in that either the statement that is the target of dependence cannot be executed normally, or the results of execution will differ from those of the sequential program. For this reason, all cases of data dependence between threaded regions must be detected during data dependence analysis.

As described above, however, since the communication code is not found in the sequential program, unnecessary communication code leads to overhead in a parallel-threaded program. Accordingly, while detecting all existing cases of data dependence, data dependence analysis is expected not to detect any data dependence that does not actually exist.

The following describes a context-sensitive analysis as a method of data dependence analysis.

### Context-Sensitive Analysis

As described in Chapter 12 of Non-Patent Literature 1, a context-sensitive analysis is an analysis of a function call that is performed in accordance with the circumstances upon each call to the function. A context-sensitive analysis performs a pointer analysis, dataflow analysis, and analysis of data dependence between statements for each function call, i.e. separately for each time a function is called, including calls to other functions. Therefore, not only is an analysis performed over the entire region being focused on, but if a certain function is called multiple times within this region, the function is analyzed for each call. Similarly, if a called function makes calls to other functions, the other functions are analyzed each time they are called.

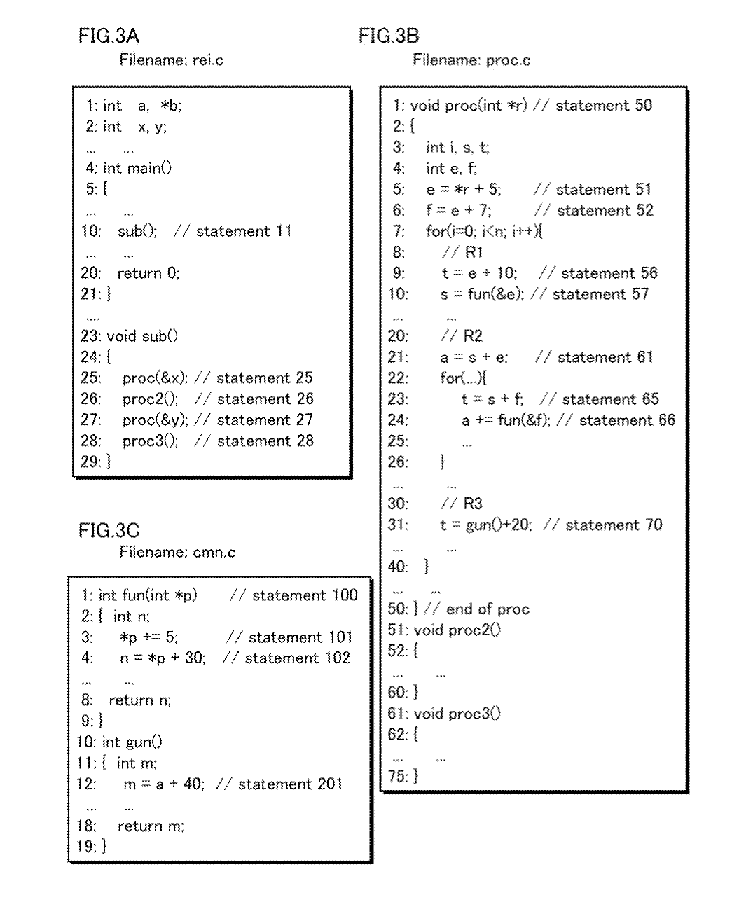

Threaded regions, communication code, pointer analysis, dataflow analysis, and data dependence analysis are now described with reference to FIGS. 3A, 3B, and 3C. FIGS. 3A, 3B, and 3C are an example of a source program, written in C/C++, that is the target of thread parallelization. FIG. 3A shows the contents of a file named rei.c, FIG. 3B shows the contents of a file named proc.c, and FIG. 3C shows the contents of a file named cmn.c. The numbers to the left are line numbers. The indication “statement+number” is the identifier for a statement. Statements are thus uniquely identified by number.

As illustrated in FIG. 3A, the first function that is executed in the program rei.c is main. The function main calls the function sub, and the function sub calls the functions proc, proc2, and proc3 in the file proc.c. Furthermore, as illustrated in FIG. 3B, the function proc calls the functions fun and gun in the file cmn.c.

In the function proc in FIG. 3B, the code from line 8 to line 19 (not shown in FIG. 3B) in the for loop of line 7 forms a region R1 to be converted into a thread. Similarly, the code from line 20 to line 29 (not shown in FIG. 3B) forms a region R2 to be converted into a thread, and the code from line 30 to line 39 (not shown in FIG. 3B) forms a region R3 to be converted into a thread.

Next, the communication code for delivering values between threads is described with reference to FIG. 3B. The value of the variable s that is assigned in statement 57 in region R1 is used in statements 61 and 65 in region R2. Therefore, data dependence caused by the variable s exists between region R1 and region R2. As a result, it is necessary to insert communication code into thread 1, which is a thread corresponding to region R1, and thread 2, which is a thread corresponding to region R2, in order to deliver the value of the variable s.

Next, with reference to FIGS. 3A through 3C, the difference between a context-sensitive analysis and a context-insensitive analysis is described with regards to a pointer analysis and a data dependence analysis. In FIG. 3B, the function fun is called in two places, statement 57 and statement 66. In the call to the function fun in statement 57, the address of the variable e is passed to the function fun as the formal parameter thereof, i.e. the pointer p. Similarly, in statement 66, the address of the variable f is passed to the function fun as the formal parameter thereof, i.e. the pointer p. Below, the call to the function fun in statement 57 is described.

In FIG. 3B, the variable e and variable f are neither assigned nor used between line 1 (not shown in FIG. 3B) and line 39 (not shown in FIG. 3B) other than in the lines indicated in FIG. 3B. Furthermore, the pointer p is neither assigned nor used between line 5 (not shown in FIG. 3C) and line 8 other than in the lines indicated in FIG. 3C. The variable referred to by the pointer p is therefore neither assigned nor used by dereferencing the pointer p, i.e. *p.

### 1. Context-Insensitive Pointer Analysis and Dataflow Analysis

First, context-insensitive pointer analysis is described. The analysis device searches for statements within the program that call the function fun and collects the values received by the function as the formal parameter, pointer p. From statement 57 and statement 66, the analysis device collects the addresses of variable e and variable f as the values passed to the pointer p.

The analysis device thus analyzes pointer p in statement 101 in the function fun as pointing to both variable e and variable f.

Next, the analysis device uses the results of the context-insensitive pointer analysis to perform context-insensitive dataflow analysis. The analysis device determines that the variable e is used in statement 61 and that the variable f is used in statement 65. The analysis device also determines that the variable e is used in statement 56 of the loop between lines 7 and 40.

Since the pointer p points to both variable e and variable f in statement 101 of the function fun, the analysis device determines that in statement 101, both variable e and variable fare used and assigned.

As a result, the analysis device determines that both variable e and variable f are assigned in the call to the function fun in statement 57, which is the source of the call to statement 101.

Next, the analysis device uses the results of the context-insensitive dataflow analysis to perform data dependence analysis. The analysis device determines that the variable f is assigned in statement 57, and that the variable f is used in statement 65. Therefore, the analysis device determines that data dependence caused by the variable f exists from statement 57 to statement 65.

Similarly, the analysis device determines that data dependence caused by the variable e exists from statement 57 to statement 61 and statement 56.

### 2. Context-Sensitive Pointer Analysis and Dataflow Analysis

In a context-sensitive analysis, the analysis device distinguishes between the call to the function fun in statement 57 and the call to the function fun in statement 66.

First, context-sensitive pointer analysis is described. The analysis device determines that in the call to the function fun in statement 57, the formal parameter of the function fun, pointer p, is the actual parameter of the function fun in statement 57, i.e. the address of the variable e. In this way, the analysis device determines that the value held by the pointer p in statement 101 of the function fun as called by statement 57 is the address of the variable e.

Next, the analysis device uses the results of the context-sensitive pointer analysis to perform context-sensitive dataflow analysis. In statement 101 of the function fun as called by statement 57, the pointer p points to the variable e, and therefore the analysis device determines that the variable e is assigned in statement 101.

The analysis device also determines that the variable e assigned in statement 101 is used in statement 61. Similarly, the analysis device determines that the variable e assigned in statement 101 is used in statement 56 due to the loop between lines 7 and 40.

Next, the analysis device uses the results of the context-sensitive dataflow analysis to perform data dependence analysis. Since the analysis device determines the variable e assigned in statement 101 is used in statement 56 and statement 61, the analysis device determines that the data dependence caused by the variable e exists from statement 101 to statement 56 and statement 61.

### 3. Discussion of Data Dependence Analysis Results

Based on the results obtained by the above analysis procedures, the context-sensitive analysis and context-insensitive analysis are now compared.

Examining the analysis results that identify statement 57 (statement 101 called by statement 57) as a source of dependence, in both cases the analysis device determines that data dependence caused by the variable e exists from statement 57 (statement 101 called by statement 57) to statement 56 and statement 61.

On the other hand, in the context-insensitive analysis, in addition to the above analysis results, the analysis device determines that data dependence caused by the variable f exists from statement 57 to statement 65. Since the value passed to the pointer p in statement 57 is the address of the variable e, however, the value of the variable f is not assigned in statement 101 of the called function fun. Therefore, no data dependence caused by the variable f exists from statement 57 to statement 65. In this way, even though no actual dependence exists, the context-insensitive analysis yields erroneous analysis results indicating the existence of data dependence. This is because the context-insensitive analysis does not distinguish between the call to the function fun in statement 57 and the call to the function fun in statement 66, treating the actual parameter f in the call to the function fun in statement 66 as the actual parameter of the function fun in statement 57 as well.

On the other hand, a context-sensitive analysis only detects data dependence that actually exists, thereby permitting a highly accurate analysis.

### Embodiment

The following describes an embodiment of the present invention with reference to the drawings. First, terminology is described in order to facilitate understanding of the embodiment of the present invention.

### Explanation of Terminology

Context-Sensitive Call Graph

A context-sensitive call graph (hereinafter simply referred to as a call graph) is a graph in which a node is generated for each function call, and a directed edge is drawn from the node of the calling function to the node of the called function. Each node has a node identifier, a calling function name, and a statement identifier of a function call statement.

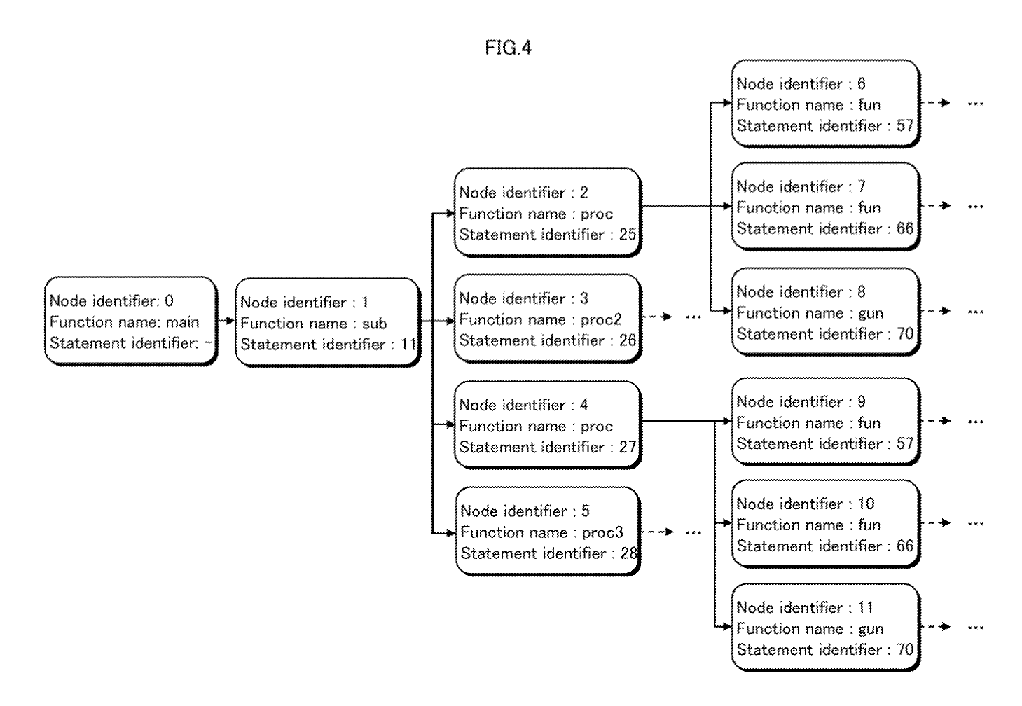

FIG. 4 is a call graph for FIGS. 3A through 3C. For example, the node with the node identifier of 2 is the node generated in correspondence with function call statement 25 in line 25 of FIG. 3A.

The node identifier is a number assigned uniquely to a node. Therefore, when focusing on a particular node, the sequence of node identifiers from the node for the function at the start of the program to the node being focused on yields a unique function call sequence. Conversely, node identifiers represent unique function call sequences. For example, node identifier 6 in FIG. 4 can be represented by a unique function call sequence in which the function sub is called in statement 11 of FIG. 3A as indicated by node identifier 1, then the function proc is called in statement 25 of FIG. 3A as indicated by node identifier 2, and then the function fun is called in statement 57 of FIG. 3B as indicated by node identifier 6.

Hereinafter, the function call sequence is referred to as the context, and the node identifier is referred to either as the context or as context information.

Note that when a function call is a recursive call or a mutual call, no node is generated for the function being called.

Sub-Call Graph

When focusing on a particular node in the call graph, the graph below the node being focused on (in the direction of the directed edge) is referred to as a sub-call graph. The node being focused on is also referred to as the top node of the sub-graph. For example, in FIG. 4, the sub-graph having the node with a node identifier of 2 as the top node is composed of node identifiers 2, 6, 7, and 8, as well as subsequent nodes and the directed edges connecting these nodes.

It is also clear that any sub-call graphs having, as the respective top nodes, nodes with the same calling function name have the same number of nodes and the same number of directed edges (hereinafter, such sub-call graphs are referred to as having the same shape). Furthermore, nodes other than the top node have the same calling function names and the same statement identifiers. For example, in FIG. 4, the calling function name for both node identifiers 2 and 4 is proc, and therefore sub-graph having identifier 2 as the top node has the same shape as the sub-graph having identifier 4 as the top node. Except for the top nodes, i.e. node identifiers 2 and 4, the remaining node identifiers 6, 7, and 8 and node identifiers 9, 10, and 11 correspond, and the calling function names and statement identifiers are the same.

Statement with Context Information

A statement with context information represents that when the same function is called from multiple locations, the statement differs for each call. Statements with context information make a context-sensitive dataflow analysis possible. For example, in FIG. 3A, the function proc is called from two locations, statement 25 and statement 27. These calls respectively correspond to node identifiers 2 and 4 in the call graph of FIG. 4. In other words, in FIG. 3A, the context for call statement 25 to the function proc is 2, whereas the context for statement 27 is 4.

A statement with context information is represented by “identifier <context>”. For example, statement 51 in the function proc in FIG. 3B is represented as statements with context information by 51<2> and 51<4>. The statements with context information make it possible to distinguish between when statement 51 is called from call statement 25 in the function proc and when statement 51 is called from call statement 27 in the function proc.

### Structure

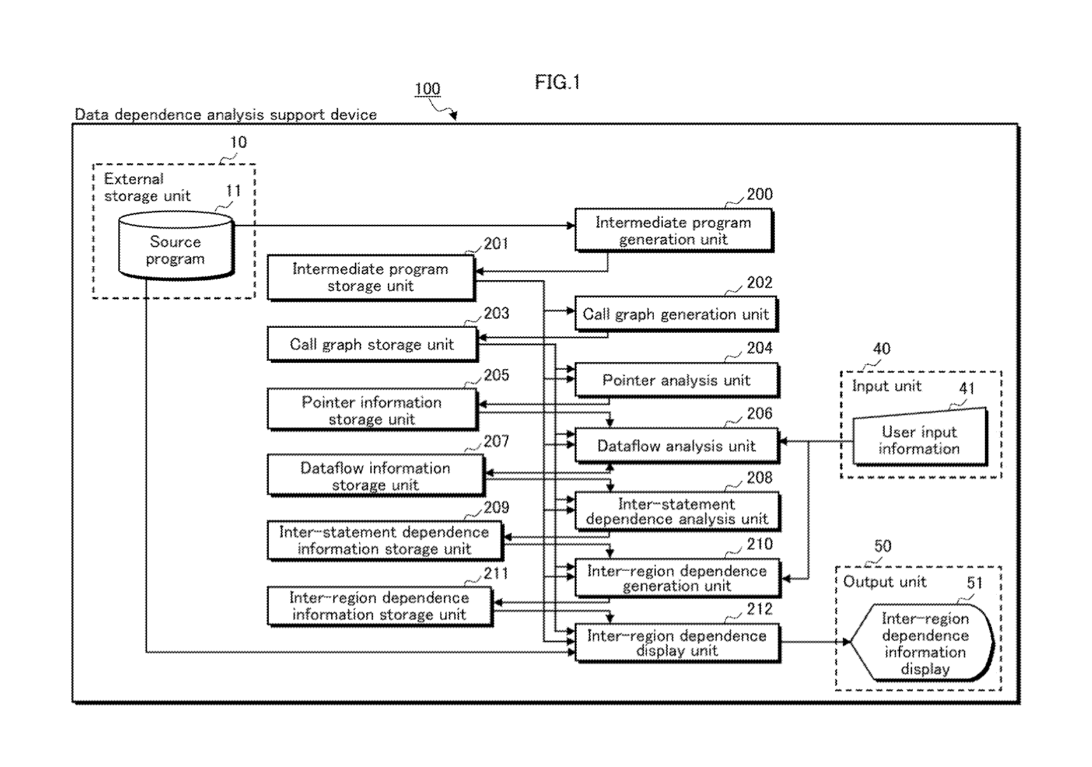

FIG. 1 is a block diagram illustrating the structure of a data dependence analysis support device 100 according to the embodiment.

The data dependence analysis support device 100 is, for example, implemented as a personal computer.

The data dependence analysis support device 100 is provided with an intermediate program generation unit 200, an intermediate program storage unit 201, a call graph generation unit 202, a call graph storage unit 203, a pointer analysis unit 204, a pointer information storage unit 205, a dataflow analysis unit 206, a dataflow information storage unit 207, an inter-statement dependence analysis unit 208, an inter-statement dependence information storage unit 209, an inter-region dependence generation unit 210, an inter-region dependence information storage unit 211, an inter-region dependence display unit 212, an external storage unit 10, an input unit 40, and an output unit 50.

The external storage unit 10 is, for example, implemented as a hard disk and stores a source program 11.

The input unit 40 is, for example, implemented as a keyboard or mouse and receives input of user input information 41 which includes information designating an analysis target region and information indicating threaded regions.

Using the parsing technology for a typical compiler listed in Non-Patent Literature 1, the intermediate program generation unit 200 reads the source program 11 stored in the external storage unit 10, generates an intermediate program, and stores the generated intermediate program in the intermediate program storage unit 201.

The intermediate program storage unit 201 stores the intermediate program generated by the intermediate program generation unit 200.

The intermediate program generated by the intermediate program generation unit 200 includes file information, function information, statement information, and information on the line numbers of the functions and statements listed in the source program file. The intermediate program generated by the intermediate program generation unit 200 may also include the other characteristics of the intermediate program listed in Chapter 6 of Non-Patent Literature 1.

The call graph generation unit 202 reads the intermediate program stored in the intermediate program storage unit 201, extracts all of the function calls, generates a context-sensitive call graph, and stores the call graph in the call graph storage unit 203.

The call graph storage unit 203 stores the call graph generated by the call graph generation unit 202.

The pointer analysis unit 204 reads the intermediate program stored in the intermediate program storage unit 201 and the call graph stored in the call graph storage unit 203, performs a context-sensitive pointer analysis across the entire intermediate program, and stores the results of analysis in the pointer information storage unit 205.

The pointer information storage unit 205 stores the results of the context-sensitive pointer analysis performed by the pointer analysis unit 204.

In this context, a piece of pointer information is a combination of a statement containing a pointer (a statement with context information), the pointer, and a collection of variables pointed to by the pointer (hereinafter referred to as a collection of pointed-to variables). The pointer information storage unit 205 stores pointer information for all of the pointers used by the source program 11.

The dataflow analysis unit 206 reads the intermediate program stored by the intermediate program storage unit 201, the context-sensitive pointer information stored by the pointer information storage unit 205, the call graph stored by the call graph storage unit 203, and the user input information 41 input from the input unit 40. The dataflow analysis unit 206 performs context-sensitive dataflow analysis on the analysis target region obtained from the analysis target region information included in the user input information 41 and stores the results of analysis in the dataflow information storage unit 207.

The dataflow information storage unit 207 stores the results of the context-sensitive dataflow analysis performed by the dataflow analysis unit 206.

The inter-statement dependence analysis unit 208 reads the intermediate program stored intermediate program storage unit 201, the call graph stored in the call graph storage unit 203, and the context-sensitive dataflow information stored in the dataflow information storage unit 207, performs a context-sensitive data dependence analysis statement by statement, and stores the results of the analysis in the inter-statement dependence information storage unit 209.

The inter-statement dependence information storage unit 209 stores the results of the analysis of context-sensitive inter-statement dependence information performed by the inter-statement dependence analysis unit 208.

In this context, each piece of inter-statement dependence information is a combination of a statement that is the source of dependence (a statement with context information), a statement that is the target of dependence (a statement with context information), and the variable the causes dependence (hereinafter referred to as the causing variable). Every piece of inter-statement dependence information is stored in the inter-statement dependence information storage unit 209.

The inter-region dependence generation unit 210 reads the intermediate program stored in the intermediate program storage unit 201, the call graph stored in the call graph storage unit 203, the context-sensitive inter-statement dependence information stored in the inter-statement dependence information storage unit 209, and the user input information 41 input from the input unit 40. The inter-region dependence generation unit 210 acquires threaded regions from region designation information included in the user input information 41, extracts inter-statement dependence information existing between threaded regions, and stores the extracted information in the inter-region dependence information storage unit 211.

The inter-region dependence information storage unit 211 stores the results of inter-region dependence information generated by the inter-region dependence generation unit 210.

Here, the threaded regions are indicated by region designation information, which is a portion of the user input information 41. Each threaded region is a portion of the analysis target region. No single statement is located in a plurality of different threaded regions. These threaded regions are designated by keyboard input of line numbers in text format, or by direct selection of particular regions in the source program 11 using a pointing device such as a mouse.

The region designation information includes a filename, starting line number of each region, and ending line number of each region.

The statements in the region meet the conditions for one of Statement A, Statement B, or Statement C below.

(1) Statement A: located in the filename of the region designation information, between the starting line number of the region and the ending line number of the region.

(2) Statement B: located within a function F when statement A is a function call statement to function F.

(3) Statement C: located within any function that might be called by a call to function F when statement A is a function call statement to function F.

Note that a “function that might be called by a call to function F” refers to functions called by function F, as well as functions that are subsequently called by these functions. In this case, a “function that is called” does not refer only to functions that are always called, but also includes functions for which at least one called path exists, such as a function that is called when a specific condition is satisfied.

Furthermore, each piece of inter-region dependence information is a combination of a region of the source of dependence and the statement that is the source of dependence (statement with context information), the region of the target of dependence and the statement that is the target of dependence (statement with context information), and the causing variable. Every piece of inter-region dependence information is stored in the inter-region dependence information storage unit 211.

The inter-region dependence display unit 212 reads the source program 11 stored in the external storage unit 10, the intermediate program stored in the intermediate program storage unit 201, the call graph stored in the call graph storage unit 203, and the inter-region dependence information stored in the inter-region dependence information storage unit 211. The inter-region dependence display unit 212 outputs the inter-region dependence information to the output unit 50.

The output unit 50 is, for example, implemented by a display and displays the inter-region dependence information.

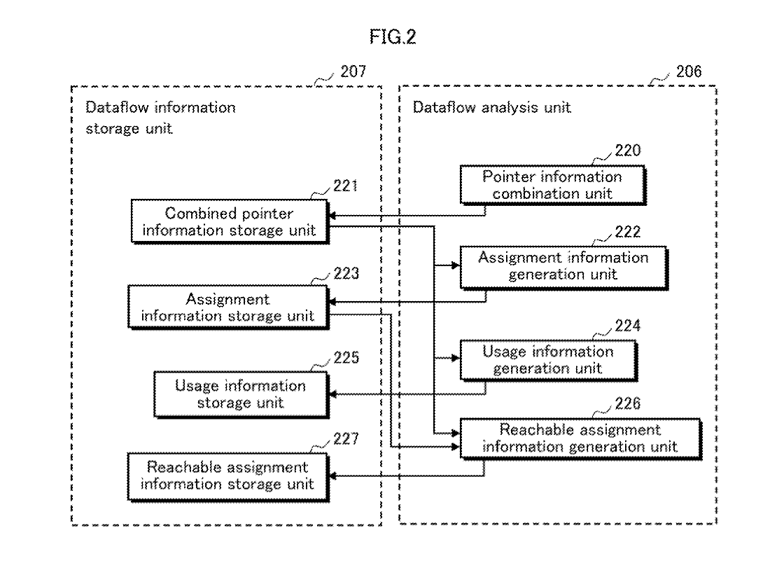

FIG. 2 is a block diagram illustrating the structure of the dataflow analysis unit 206 and the dataflow information storage unit 207 in FIG. 1.

The dataflow analysis unit 206 is provided with a pointer information combination unit 220, an assignment information generation unit 222, a usage information generation unit 224, and a reachable assignment information generation unit 226. The dataflow information storage unit 207 is provided with a combined pointer information storage unit 221, an assignment information storage unit 223, a usage information storage unit 225, and a reachable assignment information storage unit 227.

The pointer information combination unit 220 reads the intermediate program stored by the intermediate program storage unit 201, the context-sensitive call graph stored by the call graph storage unit 203, the context-sensitive pointer information stored by the pointer information storage unit 205, and the user input information 41 input by the input unit 40. Based on a sub-call tree having, as the top node, a function that includes all of the regions obtained from the analysis target region information included in the user input information 41, the pointer information combination unit 220 combines the pointer information related to the sub-call tree and stores the results of combination in the combined pointer information storage unit 221.

The combined pointer information storage unit 221 stores the pointer information combined by the pointer information combination unit 220.

The assignment information generation unit 222 reads the intermediate program stored by the intermediate program storage unit 201, the context-sensitive call graph stored by the call graph storage unit 203, and the combined pointer information stored by the combined pointer information storage unit 221. The assignment information generation unit 222 then generates context-sensitive assignment information, which indicates what the variable is that is assigned in each statement and the function call under which the variable is assigned, and stores the generated information in the assignment information storage unit 223.

The assignment information storage unit 223 stores the context-sensitive assignment information generated by the assignment information generation unit 222.

The usage information generation unit 224 reads the intermediate program stored by the intermediate program storage unit 201, the context-sensitive call graph stored by the call graph storage unit 203, and the combined pointer information stored by the combined pointer information storage unit 221. The usage information generation unit 224 then generates context-sensitive usage information, which indicates what the variable is that is used in each statement and the function call under which the variable is used, and stores the generated information in the usage information storage unit 225.

The usage information storage unit 225 stores the context-sensitive usage information generated by the usage information generation unit 224.

The reachable assignment information generation unit 226 reads the intermediate program stored by the intermediate program storage unit 201, the context-sensitive call graph stored by the call graph storage unit 203, and the context-sensitive assignment information stored by the assignment information storage unit 223. The reachable assignment information generation unit 226 then generates context-sensitive reachable assignment information, which indicates what the statement is that is reachable in each statement and the function call under which the statement is reachable, and stores the generated information in the reachable assignment information storage unit 227.

The reachable assignment information storage unit 227 stores the context-sensitive reachable assignment information generated by the reachable assignment information generation unit 226.

In this context, as described in Non-Patent Literature 1, when a variable x is assigned in a certain statement A, and among a plurality of execution paths leading from statement A to statement B, there is at least one path in which no statement other than statement A assigns a value to the variable x, i.e. when there is a path in which the only statement that assigns a value to the variable x is statement A, then statement A can reach statement B.

### Operations

The following describes operations of the data dependence analysis support device 100.

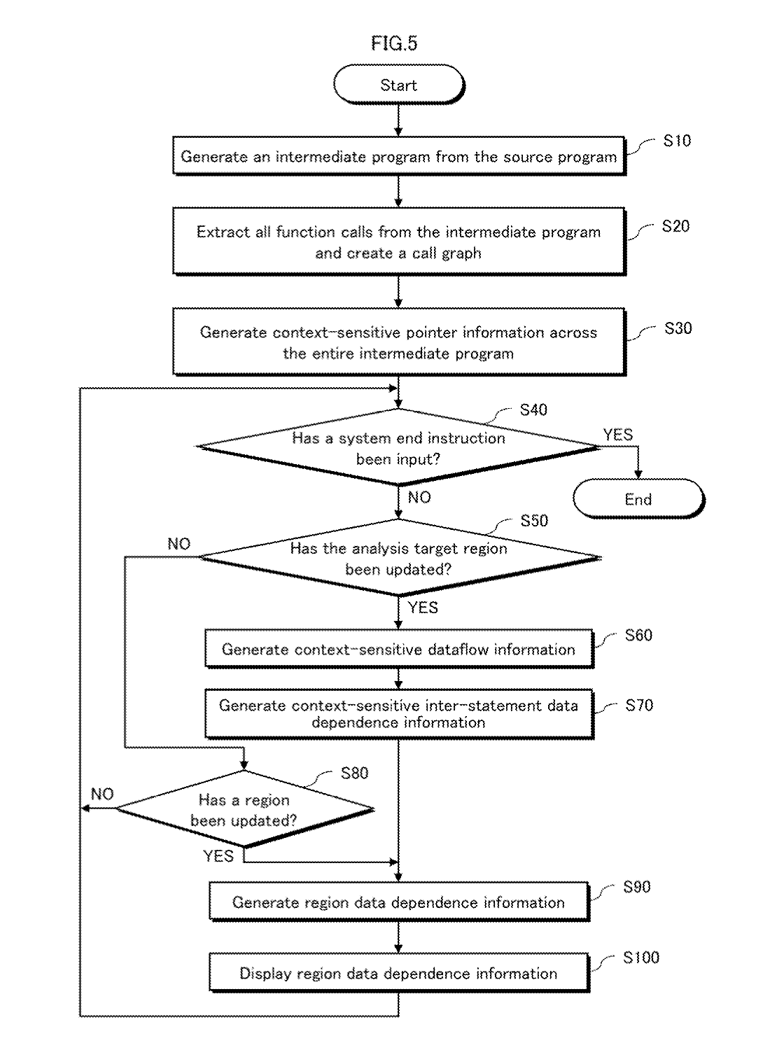

FIGS. 5 through 7 are flowcharts illustrating operations for data dependence analysis support processing by the data dependence analysis support device 100.

With reference to FIG. 5, the following describes an outline of operations by the data dependence analysis support device 100.

The data dependence analysis support device 100 starts up the intermediate program generation unit 200. The intermediate program generation unit 200 reads the source program 11 from the external storage unit 10, generates an intermediate program, and stores the intermediate program in the intermediate program storage unit 201 (S10).

Next, the data dependence analysis support device 100 starts up the call graph generation unit 202. The call graph generation unit 202 reads the intermediate program stored in the intermediate program storage unit 201, extracts all of the function calls from the intermediate program, generates a context-sensitive call graph, and stores the generated call graph in the call graph storage unit 203 (S20).

Next, the data dependence analysis support device 100 starts up the pointer analysis unit 204. The pointer analysis unit 204 reads the intermediate program stored in the intermediate program storage unit 201, performs a context-sensitive pointer analysis across the entire intermediate program, and stores the generated pointer information in the pointer information storage unit 205 (S30).

Next, the data dependence analysis support device 100 reads the user input information 41 input from the input unit 40. The data dependence analysis support device 100 terminates the system when a system end instruction is included in the user input information 41, and otherwise refers to the analysis target region information included in the user input information 41 (S40).

Next, the data dependence analysis support device 100 proceeds to S60 when the analysis target region information has been newly acquired or has been updated and proceeds to S80 when no update has occurred since the previous analysis (S50).

Next, the data dependence analysis support device 100 starts up the dataflow analysis unit 206, reads the intermediate program stored in the intermediate program storage unit 201, the context-sensitive pointer information stored in the pointer information storage unit 205, and user input information 41 input from the input unit 40, and performs a context-sensitive dataflow analysis of the analysis target region obtained from the analysis target region information included in the user input information 41 and of all of the statements that might be called upon execution of the analysis target region (S60).

Here, the data dependence analysis support device 100 starts up units in the order of the pointer information combination unit 220, the assignment information generation unit 222, the usage information generation unit 224, and the reachable assignment information generation unit 226.

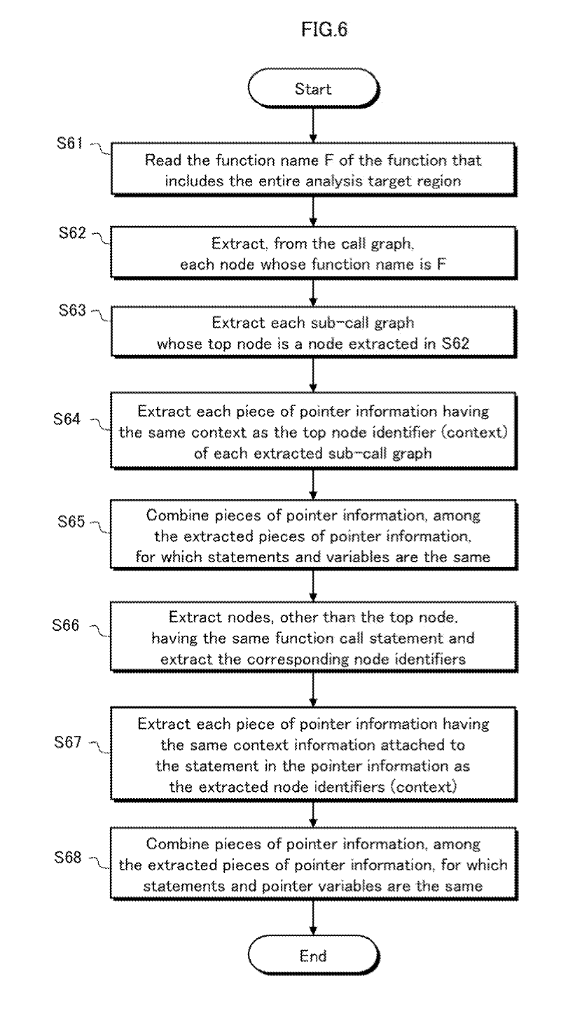

FIG. 6 is a flowchart illustrating operations of the pointer information combination unit 220.

First, the pointer information combination unit 220 reads the function name F of the function that includes the entire analysis target region based on the analysis target region information included in the user input information 41 (S61).

Next, the pointer information combination unit 220 extracts, from the call graph, each node whose calling function name is F (S62).

Next, the pointer information combination unit 220 extracts each sub-call graph whose top node is a node extracted in S62 (S63). As described above, when a plurality of sub-call graphs are extracted at this point, all of the sub-call graphs have the same shape.

Next, the pointer information combination unit 220 extracts each piece of pointer information having the same context information attached to the statement in the pointer information as the node identifier (context) of the top node of each sub-call graph extracted in S63 (S64).

Next, the pointer information combination unit 220 combines pieces of pointer information, among the pieces of pointer information extracted in S64, for which statements and variables are the same (S65). Here, “combines pieces of pointer information” refers to combining the context information attached to the statement and the collection of pointed-to variables.

Next, for nodes other than the top node in each sub-call graph extracted in S63, the pointer information combination unit 220 extracts nodes having the same function call statement and extracts the corresponding node identifiers (S66).

Next, the pointer information combination unit 220 extracts each piece of pointer information having the same context information attached to the statement in the pointer information as the node identifiers (context) extracted in S66 (S67).

Next, the pointer information combination unit 220 combines pieces of pointer information, among the pieces of pointer information extracted in S67, for which statements and pointers are the same (S68).

Through these operations, the pieces of pointer information for the plurality of sub-call graphs having the same shape extracted in S63 are restructured as pointer information for one sub-call graph. Since only the analysis target region is the target of dataflow analysis, the identifiers of the top nodes of the extracted sub-call graphs may be considered to be the same during the dataflow analysis.

After combination of the pointer information, the assignment information generation unit 222, the usage information generation unit 224, and the reachable assignment information generation unit 226 use the statements with context information to perform a context-sensitive intermediate program analysis and generate assignment information indicating the statements in which variables are assigned, usage information indicating the statements which variables are used, and reachable assignment information indicating whether statements are reachable.

Next, the data dependence analysis support device 100 starts up the inter-statement dependence analysis unit 208, reads the intermediate program stored in the intermediate program storage unit 201, the call graphs stored in the call graph storage unit 203, the assignment information stored in the assignment information storage unit 223, the usage information stored in the usage information storage unit 225, and the reachable assignment information stored in the reachable assignment information storage unit 227, and then performs a context-sensitive data dependence analysis statement by statement (S70). Next, the data dependence analysis support device 100 proceeds to S90.

Here, when the analysis target region information has not been updated since the previous analysis (S50: NO), the data dependence analysis support device 100 reads the user input information 41 input from the input unit 40. When the region designation information included in the user input information 41 has been updated, the data dependence analysis support device 100 proceeds to S90, otherwise proceeding to S40 (S80).

When the region designation information has been updated (S80: YES), the data dependence analysis support device 100 starts up the inter-region dependence generation unit 210, reads the context-sensitive inter-statement dependence information stored in the inter-statement dependence information storage unit 209 and the user input information 41 input from the input unit 40, and generates inter-region dependence information existing between regions obtained from the region designation information included in the user input information 41 (S90).

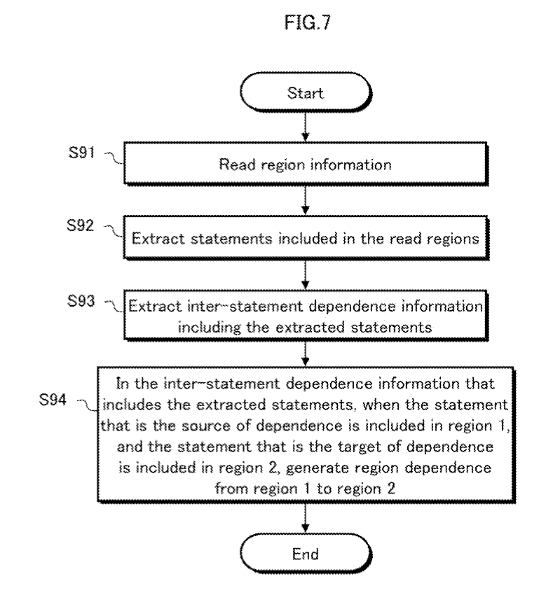

FIG. 7 is a flowchart illustrating operations of the inter-region dependence generation unit 210.

The inter-region dependence generation unit 210 reads region information from the region designation information included in the user input information 41 (S91).

Next, the inter-region dependence generation unit 210 extracts statements included in the regions acquired in S91 (S92).

Next, the inter-region dependence generation unit 210 extracts inter-statement dependence information in which the source of dependence and the target of dependence are statements extracted in S92 (S93). It suffices for the statement that is the source of dependence and the statement that is the target of dependence to be a statement extracted in S92. The statement that is the source of dependence and the statement that is the target of dependence may be the same statement or may be different statements.

Next, in the inter-statement dependence information that includes the statements extracted in S93, when the statement that is the source of dependence is included in a certain region 1, and the statement that is the target of dependence is included in a certain region 2, then the inter-region dependence generation unit 210 generates inter-region dependence information from region 1 to region 2 (S94). Region 1 and region 2 are different regions. When the statement that is the source of dependence and the statement that is the target of dependence are included in the same region, the inter-statement dependence information is not included in the inter-region dependence information.

Next, the data dependence analysis support device 100 starts up the inter-region dependence display unit 212. The inter-region dependence display unit 212 reads the source program 11 stored in the external storage unit 10, the intermediate program stored in the intermediate program storage unit 201, the call graph stored in the call graph storage unit 203, and the inter-region dependence information stored in the inter-region dependence information storage unit 211. The inter-region dependence display unit 212 then displays the inter-region dependence information on an output device 50 (S100).

Next, after termination of S100, the data dependence analysis support device 100 proceeds to S40.

### Specific Example

With reference to the flowcharts in FIGS. 5 through 7, the following describes operations by the data dependence analysis support device 100 when the source program 11 in FIG. 1 is the programs in FIGS. 3A through 3C.

The data dependence analysis support device 100 starts up the intermediate program generation unit 200. The intermediate program generation unit 200 reads the source program 11 from the external storage unit 10, converts the source program 11 into an intermediate program, and stores the intermediate program in the intermediate program storage unit 201 (S10).

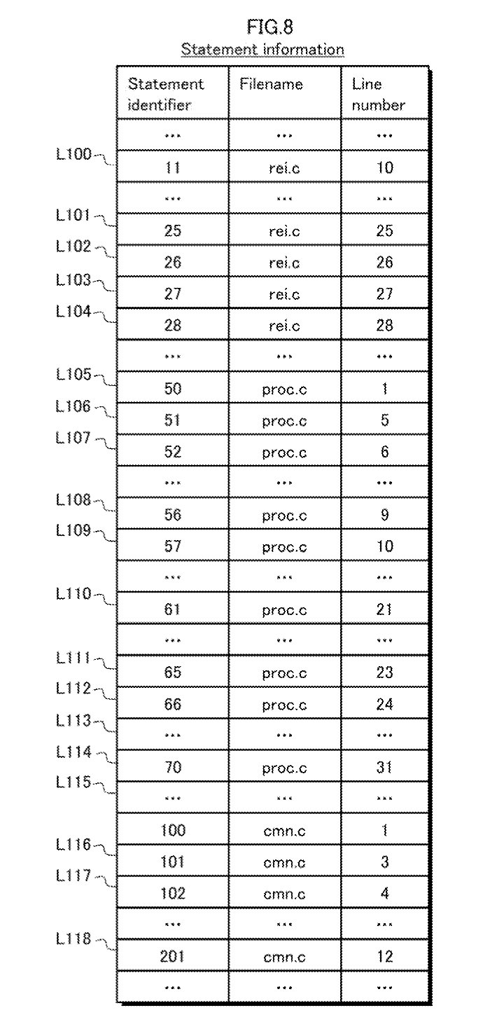

FIG. 8 illustrates information on statements included in the intermediate program for the source program 11 in FIGS. 3A through 3C. FIG. 8 lists statement identifiers, the filenames of the files in which statements are located, and the line numbers within the files. For example, line L100 shows the function call to the function sub in statement 11 in FIGS. 3A through 3C. The statement identifier is 11, the filename of the file is rei.c, and the line number of the function call is 10.

Next, the data dependence analysis support device 100 starts up the call graph generation unit 202. The call graph generation unit 202 generates a context-sensitive call graph (S20). As described above, the call graph in FIG. 4 is generated for the source program 11 in FIGS. 3A through 3C.

Next, the data dependence analysis support device 100 starts up the pointer analysis unit 204. The pointer analysis unit 204 reads the intermediate program stored in the intermediate program storage unit 201 and performs a context-sensitive pointer analysis across the entire intermediate program (S30).

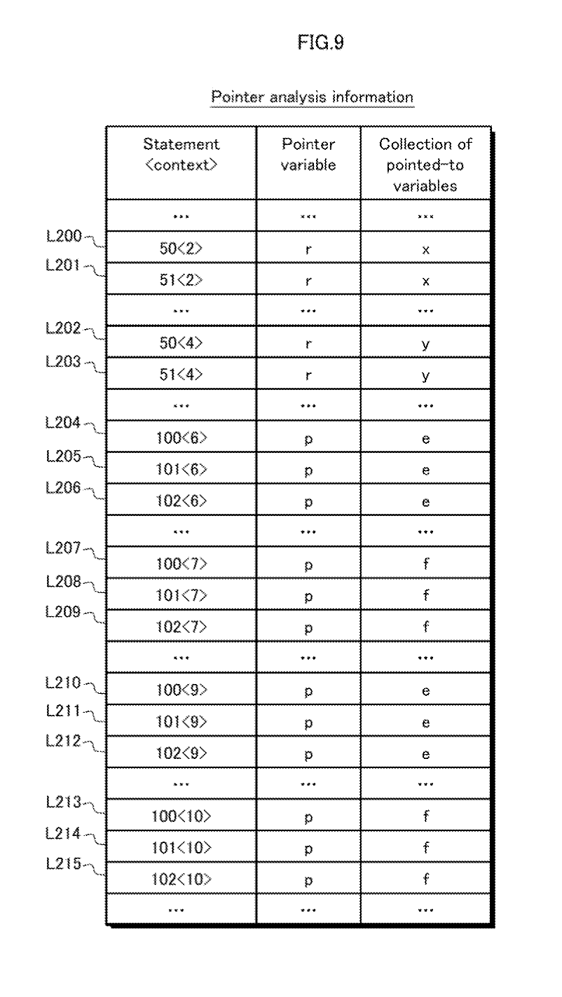

FIG. 9 shows pointer information for the source program 11 in FIGS. 3A through 3C. Statements with context information, pointers, and collections of pointed-to variables are included in the pointer information. For example, line L203 of FIG. 9 indicates that for statement 51 in FIG. 3B with context 4, the variable pointed to by pointer r is y.

The data dependence analysis support device 100 reads the user input information 41 input from the input unit 40 and determines whether system end information included in the user input information 41 is input requesting termination (end) of the system (S40).

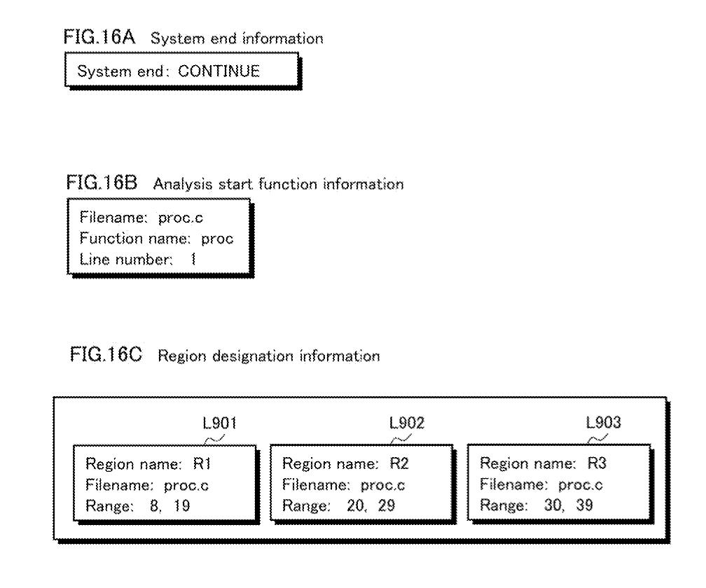

The system end information is illustrated in FIG. 16A. The data dependence analysis support device 100 terminates the system when the system end information is END and continues execution of the system when the system end information is CONTINUE. Here, since the system end information is CONTINUE, execution of the system continues.

Next, the data dependence analysis support device 100 refers to the analysis target region information included in the user input information 41. When the analysis target region information has been newly acquired or updated, processing proceeds to S60, and when the analysis target region information has not been updated, processing proceeds to S80 (S50).

FIG. 16B illustrates the analysis target region information. Here, the entire function with the function name proc located at line 1 of the file with the file name proc.c is designated as the analysis target region.

Next, the data dependence analysis support device 100 starts up the dataflow analysis unit 206 and performs a context-sensitive dataflow analysis of the function proc, which is the analysis target region obtained from the analysis target region information included in the user input information 41, and of all of the statements that might be called upon execution of the function proc (S60).

The following describes the dataflow analysis unit 206 in further detail.

The data dependence analysis support device 100 starts up the pointer information combination unit 220 in the dataflow analysis unit 206. The pointer information combination unit 220 reads the function name of the function including the entire analysis target region based on the analysis target region information (S61). Here, the analysis target region is the entire function proc. Therefore, the function including the entire analysis target region is, of course, the function proc.

Next, the pointer information combination unit 220 extracts, from the call graph, each node whose calling function name is proc, namely the nodes with node identifiers 2 and 4 (S62).

Next, the pointer information combination unit 220 extracts the sub-call graphs whose top nodes are respectively the nodes with node identifiers 2 and 4 extracted in S62 (S63).

Next, the pointer information combination unit 220 extracts each piece of pointer information having the same context information attached to the statement in the pointer information as the node identifier (context) of the top node of each sub-call graph extracted in S63 (S64).

The pointer analysis information for lines L200 and L201 in FIG. 9 is extracted for node identifier 2, which is the top node in the sub-call graph illustrated in FIG. 4. Similarly, lines L202 and L203 in FIG. 9 are extracted for node identifier 4.

Next, the pointer information combination unit 220 combines pieces of pointer information, among the pieces of pointer information extracted in S64, for which statements and variables are the same (S65).

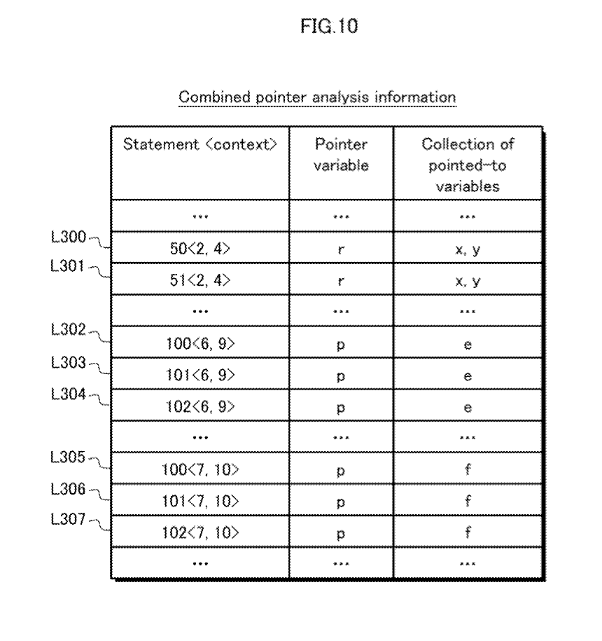

FIG. 10 shows pointer analysis information after combination. Line L300 is a combination of lines L200 and L202 extracted from FIG. 9, and line L301 is a combination of lines L201 and L203 extracted from FIG. 9.

Next, for nodes other than the top node in each sub-call graph, the pointer information combination unit 220 extracts nodes having the same function call statement and extracts the corresponding node identifiers (S66).

In FIG. 4, node identifiers 6, 7, and 8 are extracted from the sub-call graph having node identifier 2 as the top node, whereas node identifiers 9, 10, and 11 are extracted from the sub-call graph having node identifier 4 as the top node.

Next, the pointer information combination unit 220 extracts each piece of pointer information having the same context information attached to the statement in the pointer information as the node identifier (context) extracted in step S66 (S67).

The pointer analysis information for lines L204, L205, and L206 in FIG. 9 are extracted for node identifier 6. Similarly, lines L207, L208, and L209 in FIG. 9 are extracted for node identifier 7, lines L210, L211, and L212 in FIG. 9 are extracted for node identifier 9, and lines L213, L214, and L215 in FIG. 9 are extracted for node identifier 10.

With regard to node identifiers 8 and 11, FIG. 9 does not include any statement information having a context of 8 or 11 because no pointers are used in statement 70 of FIG. 3B.

Next, the pointer information combination unit 220 combines pieces of pointer information, among the pieces of pointer information extracted in step S67, for which statements and variables are the same (S68).

FIG. 10 shows pointer analysis information after combination. Line L302 is a combination of lines L204 and L210 extracted from FIG. 9, line L303 is a combination of lines L205 and L211 extracted from FIG. 9, and line L304 is a combination of lines L206 and L212 extracted from FIG. 9. Furthermore, line L305 is a combination of lines L207 and L213 extracted from FIG. 9, line L306 is a combination of lines L208 and L214 extracted from FIG. 9, and line L307 is a combination of lines L209 and L215 extracted from FIG. 9.

Next, the data dependence analysis support device 100 starts up the assignment information generation unit 222, the usage information generation unit 224, and the reachable assignment information generation unit 226 in the dataflow analysis unit 206 in this order and performs a context-sensitive dataflow analysis on the analysis target region included in the user input information 41.

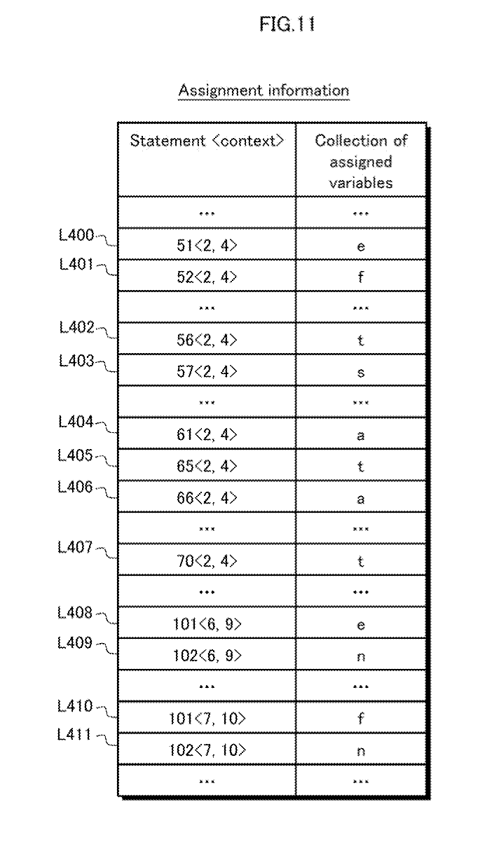

FIG. 11 is assignment information. For example, line L400 indicates that in statement 51 in FIG. 3B with context 2 and 4, variable e is assigned.

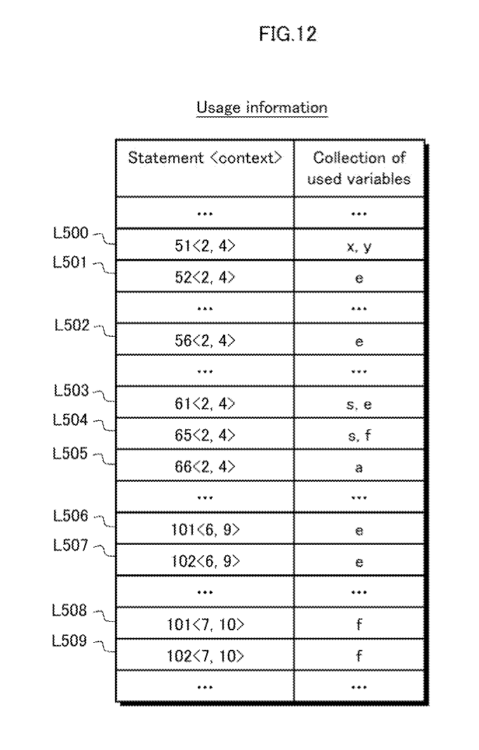

FIG. 12 is usage information. For example, line L500 indicates that in statement 51 in FIG. 3B with context 2 and 4, variables x and y are used.

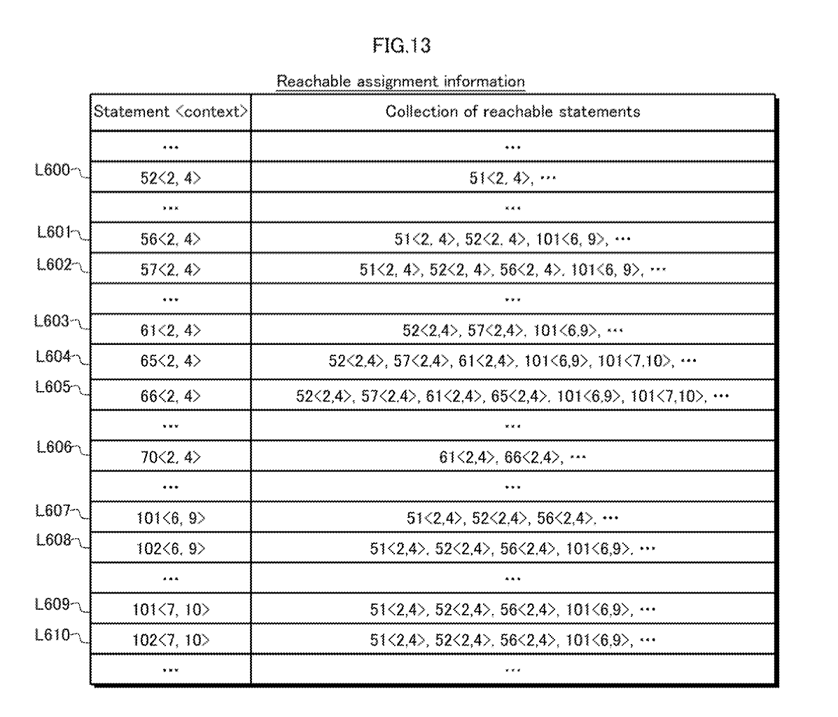

FIG. 13 is reachable assignment information. For example, line L601 indicates that statements that can reach statement 56 in FIG. 3B with context 2 and 4 include statements 51 and 52 in FIG. 3B with context 2 and 4, as well as statement 101 in FIG. 3C with context 6 and 9.

The reason why statements that can reach statement 56 include statement 101 in FIG. 3C with context 6 and 9 is as follows. First, when function fun is called in statement 57 of FIG. 3B, the address of variable e is passed to pointer p in statement 100 of FIG. 3C. In statement 101 of FIG. 3C, the variable e is assigned by dereferencing the pointer p. Next, after execution of statement 57 in the for loop, control proceeds to line 7 in FIG. 3B. No statement assigning the variable e is located between line 11 (not shown in FIG. 3B) and line 40 (not shown in FIG. 3B) of FIG. 3B. As a result, the value of variable e assigned in statement 101 of FIG. 3C is kept by the variable e in statement 56 of FIG. 3B.

Next, the data dependence analysis support device 100 starts up the inter-statement dependence analysis unit 207. The inter-statement dependence analysis unit 207 performs a context-sensitive data dependence analysis statement by statement (S70).

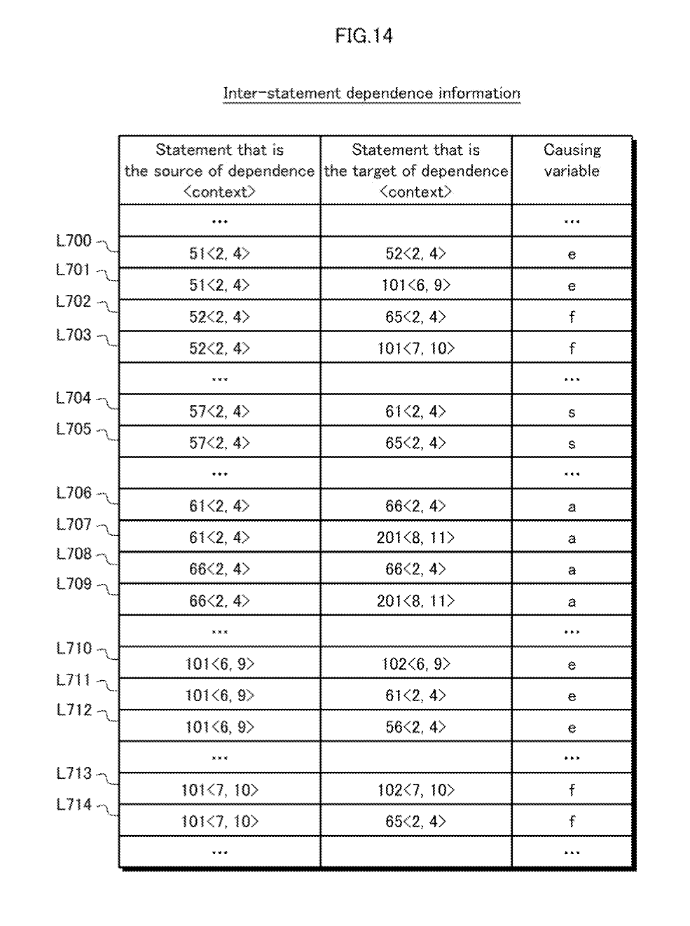

FIG. 14 shows inter-statement dependence analysis information. For example, line L711 is calculated as follows. First, statement 101 in FIG. 3C with context 6 and 9 is extracted from line L603 of FIG. 13 as a statement that can reach statement 61 in FIG. 3B with context 2 and 4. Next, in line L408 of the assignment information in FIG. 11, it is discovered that the variable assigned in statement 101 with context 6 and 9 is the variable e. Then, in line L503 of the usage information in FIG. 12, it is discovered that the variable e is used in statement 61 with context 2 and 4. As a result, dependence is calculated with variable e as the causing variable from statement 101 with context 6 and 9 to statement 61 with context 2 and 4. This is because if all three of the following conditions are satisfied, then the dependence exists from statement 1 to statement 2 with variable x as the causing variable: (1) variable x is assigned in statement 1, (2) variable x is used in statement 2, and (3) statement 1 can reach statement 2.

Next, the data dependence analysis support device 100 proceeds to S90. The following describes the region designation information.

The region designation information is illustrated in FIG. 16C. In FIG. 16C, the region name corresponds to the name of the region, the filename corresponds to the name of the file with the designated region, and the range corresponds to the range of the region by line number. For example, in line L901, the name of the region is R1, the filename is proc.c, and the range is from line 8 to line 19. Entries L902 and L903 are similar.

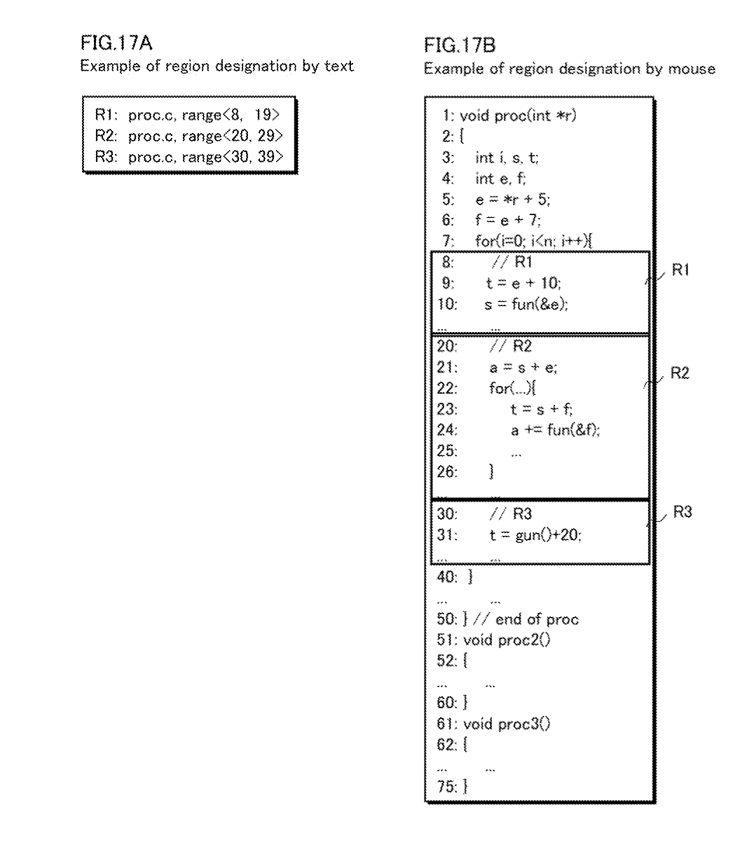

This region designation may be input by text or designated with the mouse. For example, FIG. 17A shows an example of input by text, where the region names are R1, R2, and R3, the filename is proc.c, and the range is “range”. On the other hand, FIG. 17B shows an example of designation with the mouse, in which three regions, R1, R2, and R3, have been designated by dragging the mouse directly over the source program 11.

Next, the data dependence analysis support device 100 starts up the inter-region dependence generation unit 210. The inter-region dependence generation unit 210 generates inter-region dependence information existing between regions obtained from the region designation information included in the user input information 41 (S90).

The following describes operations of the inter-region dependence generation unit 210 in further detail.

The inter-region dependence generation unit 210 reads region information from the region designation information included in the user input information 41 (S91). As described above, FIG. 16C illustrates the region information.

Next, the inter-region dependence generation unit 210 extracts statements included in the regions acquired in S91 (S92).

Region R1 in L901 of FIG. 16C is as follows. The statements included from line 8 to line 19 in the file proc.c are statements 56 and 57 in FIG. 3B. Furthermore, as described above, the statements included in the region also include statements within functions that are called. Hence, region R1 also includes statements 100, 101, and 102 in FIG. 3C. Similarly, the statements included in region R2 in L902 of FIG. 16C are statements 61, 65, and 66 in FIG. 3B, as well as statements 100, 101, and 102 in FIG. 3C. Finally, the statements included in region R3 in L903 of FIG. 16C are, similarly, statement 70 in FIG. 3B and statement 201 in FIG. 3C.

Next, the inter-region dependence generation unit 210 extracts inter-statement dependence information in which the source of dependence and the target of dependence are statements extracted in S92 (S93).

For example, in line L704 in FIG. 14, the source of dependence is statement 57, and the target of dependence is statement 61. Both of these statements are included in the statements extracted in S92 and are therefore extracted as the target of inter-statement dependence information. Similarly, lines L705, L706, L707, L710, L711, L712, L713, and L714 in FIG. 14 are extracted.

Next, in the inter-statement dependence information that includes the statements extracted in S93, when the statement that is the source of dependence is included in region 1, and the statement that is the target of dependence is included in region 2, then the inter-region dependence generation unit 210 generates inter-region dependence information from region 1 to region 2 (S94).

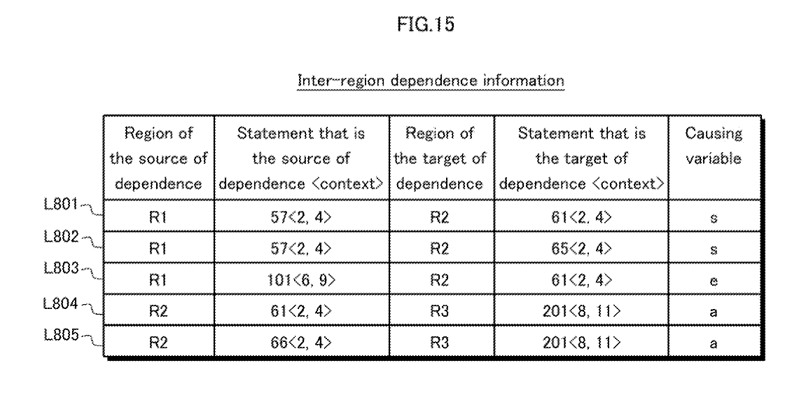

FIG. 15 illustrates inter-region dependence information. For example, line L801 is generated from line L704 in FIG. 14 as follows. In line L704 in FIG. 14, the statement that is the source of dependence is statement 57, which is included in region R1, and the statement that is the target of dependence is statement 61, which is included in region R2. These pieces of inter-region dependence information are therefore extracted as inter-region dependence, and inter-region dependence information with the addition of region information is generated. In a similar way, the other lines in FIG. 15, lines L802, L803, L804, and L805, are respectively generated from lines L705, L711, L707, and L709 in FIG. 14. On the other hand, since for example in line L706 in FIG. 14, the statement that is the source of dependence, statement 61, and the statement that is the target of dependence, statement 66, are included in the same region R2 and therefore are not extracted as inter-region dependence information.

Next, the data dependence analysis support device 100 starts up the inter-region dependence display unit 212. The inter-region dependence display unit 212 displays the inter-region dependence information on the output device 50 (S100).

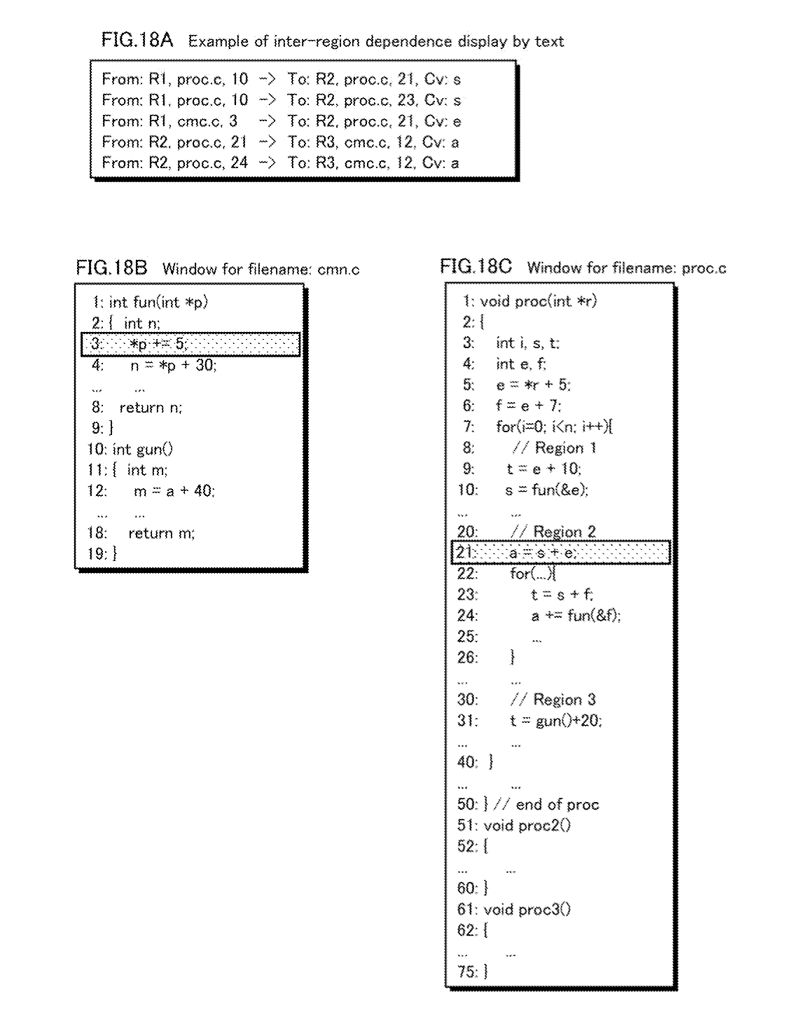

FIGS. 18A through 18C illustrate examples of inter-region dependence display. FIG. 18A is an example of displaying the inter-region dependence information as text. For example, “From: R1, proc.c, 10->To: R2, proc.c, 21: Cv:s” indicates that dependence, caused by variable s, exists from line 10 in the file proc.c in region R1 to line 21 in the file proc.c in region R2. This information is calculated from the inter-region dependence information in FIG. 15 and the statement information in FIG. 8. For example, in line L801 in FIG. 15, the statement that is the source of dependence is statement 57. The location of statement 57, i.e. line 10 of the file proc.c, is extracted from line L109 of FIG. 8. Similarly, the target of dependence of line L801 in FIG. 15 is statement 61, and information indicating line 21 in the file proc.c is extracted from line L110 of FIG. 8 and displayed.

FIGS. 18B and 18C are examples of displaying the inter-region dependence information on the source program 11. FIGS. 18B and 18C illustrate examples of displaying inter-region dependence for line L803 in FIG. 15. In line L803 of FIG. 15, the statement that is the source of dependence is statement 101. The location of statement 101, i.e. line 10 of the file cmn.c, is extracted from line L108 of FIG. 8. Similarly, for statement 61, the target of dependence, information indicating line 21 in the file proc.c is extracted. Next, a window is opened to display the file for the source of dependence, cmn.c, with line 10 highlighted (FIG. 18B). Furthermore, a window is opened to display the file for the target of dependence, proc.c, with line 21 highlighted (FIG. 18C). The same holds for other inter-region dependences in FIG. 15. In the case that the source of dependence and the target of dependence are in the same file, however, the line numbers for both the source of dependence and the target of dependence may be highlighted in the same window.

Next, the data dependence analysis support device 100 proceeds to S40.

As long as there is no request in the user input information 41 to terminate the system in S40, the data dependence analysis support device 100 repeats the processing from S40 to S100.

When there is a change to the analysis target region in S50, the data dependence analysis support device 100 performs a dataflow analysis on the new analysis target region and calculates the inter-region dependence information. At this point, the pointer information generated in S30 is reused, thereby shortening the analysis time.

Furthermore, when there is no change to the analysis target region in S50, the data dependence analysis support device 100 proceeds to S80. When there is a change in the regions in S80, i.e. when calculating inter-region dependence information for different regions within the same analysis target region, the dataflow information and the inter-statement dependence information calculated in S60 and S70 are reused, thereby shortening the analysis time. In other words, rapid display of inter-region dependence information for a variety of regions designated by the user is possible.

Example of Parallelization of Threads in Source Program after Data Dependence Analysis

As described above, when the data dependence analysis support device 100 sets the regions shown in FIGS. 17A and 17B in the source program 11 of FIGS. 3A through 3C, inter-region dependence information as illustrated in FIGS. 18A through 18C is obtained. To illustrate the usefulness of the obtained inter-region dependence information, the following describes an example of threading the source program 11 in FIGS. 3A through 3C.

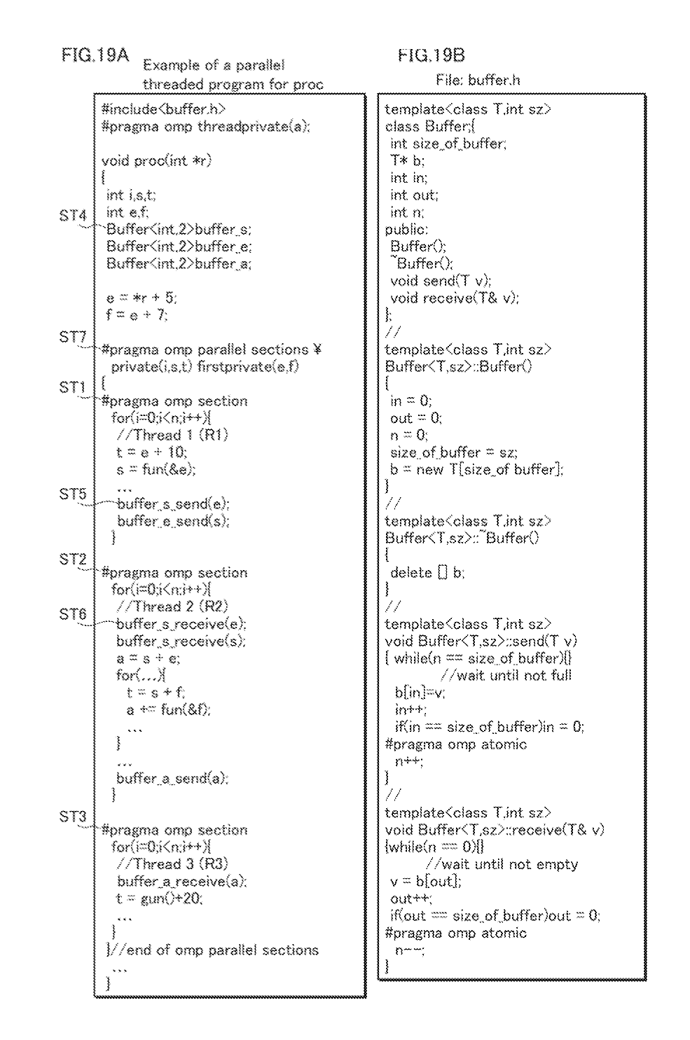

FIGS. 19A and 19B are an example of threading the program in FIGS. 3A through 3C in OpenMP format. As illustrated in FIG. 19A, three regions are converted into threads by the code “#pragma omp section” in ST1, ST2, and ST3 within the program.

Furthermore, the “buffer_x” in ST4 of FIG. 19A (where x is s, e, or a) is data provided for data delivery between threads for each causing variable x. For example, buffer_s is data provided in correspondence with the causing variable s in lines L801 and L802 of FIG. 15.

Furthermore, within FIG. 19A the operation “buffer_s_send(s)” in thread 1 in ST5 indicates transmission of the value of variable s to buffer_s, whereas the operation “buffer_s_receive(s)” in thread 2 in ST6 indicates reception of the value of variable s from buffer_s. In other words, buffer_s_send(s) and buffer_s_receive(s) are communication code inserted between regions.

Note that as indicated in ST7 of FIG. 19A, after the source program 11 is converted into threads, the variable s is declared as a local variable in each thread. In other words, the variable s is prepared for each thread, thereby guaranteeing that no race among a plurality of threads to write to the variable s occurs, nor does reference to an incorrect value occur due to another thread writing to the variable s.

The other pieces of inter-region dependence information are similarly used for conversion to threads.

The file buffer.h in FIG. 19B is an example of a detailed program for the Buffer class, which is communication code. It suffices for the user to include buffer.h as a header file in the program converted into parallel threads. It is not necessary to prepare a different header file for each source program 11, nor is it necessary to add any code to the source program 11 other than the communication code “buffer_x_send(x)” and “buffer_x_receive(x)” (x being a variable name) inserted above.

With the above method, the user can easily create a parallel-threaded program based on inter-region dependence information.

### Supplementary Explanation

While a data dependence analysis support device according to the present invention has been described above based on an embodiment, the present invention is of course not limited to the above embodiment.

(1) In the present embodiment, the analysis target region information and the region designation information are extracted from the user input information 41 input from the input unit 40, but the present invention is not limited to this case. For example, these pieces of information may be extracted from information such as comments, predetermined keywords, or special symbols included in the source program 11.

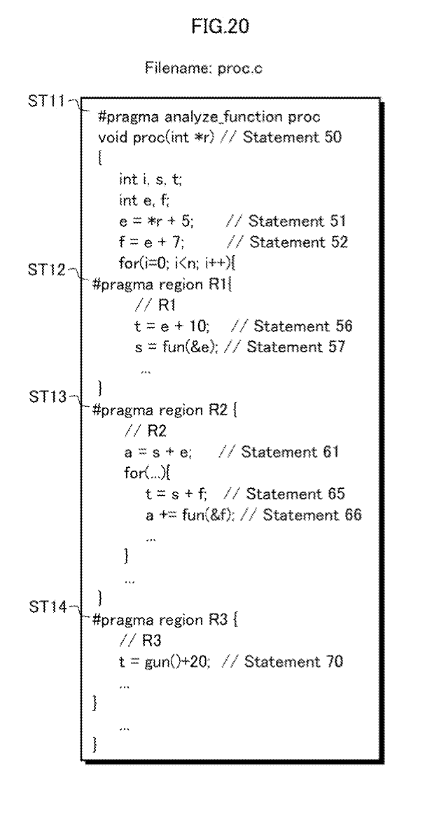

For example, FIG. 20 is an example of indicating the analysis target region information and the region designation information by listing “pragma” in the source program 11 of FIG. 3B. ST11 in FIG. 20 is an example of analysis target region information. Specifying the function name after analyze_function indicates that the entire function proc is the analysis target region. Furthermore, ST12, ST13, and ST14 in FIG. 20 are region indications. “#pragma region Region Name { . . . }” indicates that the content of { . . . } is the threaded region indicated by “Region Name”.

(2) In the present embodiment, the case has been described in which the analysis target region is the entire function proc that includes regions R1, R2, and R3, but the present invention is not limited to this case. For example, the user may designate, as the analysis target region, “lines 7 through 40 in the file proc.c”, which include all of regions R1, R2, and R3 in the source program 11 in FIGS. 3A through 3C, as well as the entire control structure for the loop and the like pertaining to these regions. In this way, it is possible to exclude, from the analysis target region, statements unrelated to the analysis of the inter-region dependence information. Note that in this case, the context of the statement included in the analysis target region is 2 or 4, and the statement with context 1, which is the source of the calls to context 2 and 4, is not included in the analysis target region. Therefore, the pointer information combination unit 220 may acquire 2 and 4 as the identifiers of the top nodes in the sub-call graphs to be extracted.

(3) In the present embodiment, the case has been described in which the inter-statement dependence information generation unit 210 generates all of the dependence information within the analysis target region as inter-statement dependence information, and the inter-region dependence information generation unit 212 generates the dependence information between regions as inter-region dependence information based on the inter-statement dependence information, but the present invention is not limited to this case. For example, the inter-statement dependence information generation unit 210 and the inter-statement dependence information storage unit 211 may be omitted. The inter-region dependence information generation unit 212 may obtain the assignment information for variables from the assignment information storage unit 223, the usage information for variables from the usage information storage unit 225, reachable assignment information from the reachable assignment information storage unit 227, and the region designation information included in the user input information 41 from the input device 40. The inter-region dependence information generation unit 212 may then generate the inter-region dependence information directly.

(4) In the present embodiment, the case has been described in which the inter-region dependence information includes the statement that is the source of dependence, the region containing the statement that is the source of dependence, the statement that is the target of dependence, the region containing the statement that is the target of dependence, and the causing variable, but the present invention is not limited to this case. For example, only the region containing the statement that is the source of dependence, the region containing the statement that is the target of dependence, and the causing variable may alternatively be included as the inter-region dependence information. This structure allows for sufficient information to be obtained to generate communication code for converting regions into parallel threads.

(5) In the present embodiment, the case has been described in which the pointer information combination unit 220 combines the pointer information stored by the pointer information storage unit 205 and stores the result in the combined pointer information storage unit 221, but the present invention is not limited to this case. For example, the pointer information combination unit 220 and the combined pointer information storage unit 221 may be omitted, and the assignment information generation unit 222, the usage information generation unit 224, and the reachable assignment information generation unit 226 may obtain the pointer information directly from the pointer information storage unit 205. In this case, variables may be combined at the time of generation of the assignment information, the storage information, and the reachable assignment information, or variables may be combined at the time of generation of the inter-statement dependence information or the inter-region dependence information.

(6) In the present embodiment, the case has been described in which inter-region data dependence analysis is performed in order to parallelize threads in the source program 11, but the present invention is not limited to this case. For example, the dataflow information stored in the dataflow information storage unit 207 of the present invention may be used for optimization of the source program 11 across functions, as described in Chapter 9 of Non-Patent Literature 1. Doing so allows for use of a program optimization method other than for parallelization of threads in the data dependence analysis support device according to the present invention, thereby accelerating the source program 11.

### SUMMARY

The following describes the structure and advantageous effects of a data dependence analysis support device, a data dependence analysis support program, and a data dependence analysis support method according to embodiments.

(1) A data dependence analysis support device according to an embodiment is for performing a context-sensitive data dependence analysis on a source program and comprises: a pointer information generation unit configured to generate pointer information by performing a context-sensitive pointer analysis on every pointer used in the source program; a dataflow information generation unit configured to generate dataflow information by performing a context-sensitive dataflow analysis, using the pointer information, on an analysis target region that is a portion of the source program and is designated for analysis of data dependence between two or more threaded regions; and an inter-region dependence information generation unit configured to generate inter-region dependence information on data dependence between the two or more threaded regions using the dataflow information, the inter-region dependence information indicating a threaded region that is a source of dependence, a threaded region that is a target of dependence, and a variable causing dependence.

A data dependence analysis support program according to another embodiment is for causing a computer to perform a context-sensitive data dependence analysis on a source program, the context-sensitive data dependence analysis comprising the steps of: generating pointer information by performing a context-sensitive pointer analysis on every pointer used in the source program; generating dataflow information by performing a context-sensitive dataflow analysis, using the pointer information, on an analysis target region that is a portion of the source program and is designated for analysis of data dependence between two or more threaded regions; and generating inter-region dependence information on data dependence between the two or more threaded regions using the dataflow information, the inter-region dependence information indicating a threaded region that is a source of dependence, a threaded region that is a target of dependence, and a variable causing dependence.

A data dependence analysis support method according to yet another embodiment is for performing a context-sensitive data dependence analysis on a source program, comprising the steps of: generating pointer information by performing a context-sensitive pointer analysis on every pointer used in the source program, the pointer information indicating correspondence between each pointer and the variable pointed to by the pointer; generating dataflow information by performing a context-sensitive dataflow analysis, using the pointer information, on an analysis target region that is a portion of the source program and is designated for analysis of data dependence between two or more threaded regions; and generating inter-region dependence information on data dependence between the two or more threaded regions using the dataflow information, the inter-region dependence information indicating a threaded region that is a source of dependence, a threaded region that is a target of dependence, and a variable causing dependence.

With the above structures, the data dependence analysis support device shortens the analysis time by performing dataflow analysis, which is a portion of processing for data dependence analysis, not over the entire source program but rather only on the analysis target region. The data dependence analysis support device can also acquire highly accurate information on dependence between threaded regions by performing a context-sensitive analysis during pointer analysis and dataflow analysis, which are a portion of processing for data dependence analysis, thereby making a highly accurate analysis compatible with a reduction in analysis time.

(2) In the above data dependence analysis support device (1) according to the embodiment, the analysis target region may be a collection of a single function and every function called by the single function, the collection including all of the two or more threaded regions.

With this structure, the data dependence analysis support device can prevent the analysis target region, which is for obtaining information on dependence between threaded regions, from being insufficient for analyzing the threaded regions. The data dependence analysis support device also allows for easy designation of the analysis target region, since the analysis target region can be designated by function name.

(3) In the above data dependence analysis support device (1) according to the embodiment, the dataflow information generation unit may generate combined pointer information by combining the pointer information for pointers used in a single function including the analysis target region and every function called by the single function, the combined pointer information treating the single function as a context.

With this structure, during the dataflow analysis on the analysis target region, the data dependence analysis support device can reduce the amount of information in the pointer information by unifying the context of a function in the pointer information when the function is included in the analysis target region and is called from outside of the analysis target region. Furthermore, the data dependence analysis support device can reduce the analysis time by avoiding unnecessary dataflow analysis.

(4) The above data dependence analysis support device (1) according to the embodiment may further comprise an analysis target region designation unit configured to receive input of information designating the analysis target region.

With this structure, the data dependence analysis support device does not need to reacquire a source program when the analysis target region is designated, thereby allowing for successive data dependence analysis of the same source program via simple operations.

(5) The above data dependence analysis support device (1) according to the embodiment may further comprise a region designation unit configured to receive input of information designating the two or more threaded regions.

With this structure, the data dependence analysis support device can easily acquire information only related to threaded regions, thereby allowing for data dependence analysis of the same analysis target region within the same source program via simple operations.

(6) The above data dependence analysis support device (1) according to the embodiment may further comprise an inter-region dependence information output unit configured to output the inter-region dependence information.

With this structure, the data dependence analysis support device can display the results of data dependence analysis to the user via an appropriate method, thus effectively supporting parallelization of the source program.

(7) In the above data dependence analysis support device (1) according to the embodiment, when the pointer information generation unit stores pointer information for a same source program, the dataflow information generation unit generates the dataflow information using the stored pointer information.

With this structure, when performing data dependence analysis on a different analysis target region in the same source program, dataflow analysis and inter-region dependence information generation can be performed by reusing the previously generated pointer information, thereby shortening the analysis time.

(8) In the above data dependence analysis support device (1) according to the embodiment, when the dataflow analysis unit stores dataflow information for a same analysis target region, the inter-region dependence information generation unit generates the inter-region dependence information using the stored dataflow information.

With this structure, when performing data dependence analysis on the same analysis target region, inter-region dependence information generation can be performed by reusing the previously generated dataflow information, thereby shortening the analysis time.

### INDUSTRIAL APPLICABILITY

A data dependence analysis support device according to the present embodiment is useful for parallelizing a source program at the region level by referring to context-sensitive inter-region dependence information, and for improving a source program by referring to context-sensitive dataflow information.

### REFERENCE SIGNS LIST

100 data dependence analysis support device
10 external storage unit
11 source program
40 input unit
41 user input information
50 output unit
200 intermediate program generation unit
201 intermediate program storage unit
202 call graph generation unit
203 call graph storage unit
204 pointer analysis unit
205 pointer information storage unit
206 dataflow analysis unit
207 dataflow information storage unit
208 inter-statement dependence analysis unit
209 inter-statement dependence information storage unit
210 inter-region dependence generation unit
211 inter-region dependence information storage unit
212 inter-region dependence display unit
220 pointer information combination unit
221 combined pointer information storage unit
222 assignment information generation unit
223 assignment information storage unit
224 usage information generation unit
225 usage information storage unit
226 reachable assignment information generation unit
227 reachable assignment information storage unit

1. A data dependence analysis support device for performing a context-sensitive data dependence analysis on a source program, comprising:
a pointer information generation unit configured to generate pointer information by performing a context-sensitive pointer analysis on every pointer used in the source program;
a dataflow information generation unit configured to generate dataflow information by performing a context-sensitive dataflow analysis, using the pointer information, on an analysis target region that is a portion of the source program and is designated for analysis of data dependence between two or more threaded regions; and
an inter-region dependence information generation unit configured to generate inter-region dependence information on data dependence between the two or more threaded regions using the dataflow information, the inter-region dependence information indicating a threaded region that is a source of dependence, a threaded region that is a target of dependence, and a variable causing dependence.

2. The data dependence analysis support device of claim 1, wherein
the analysis target region is a collection of a single function and every function called by the single function, the collection including all of the two or more threaded regions.

3. The data dependence analysis support device of claim 1, wherein
the dataflow information generation unit generates combined pointer information by combining the pointer information for pointers used in a single function including the analysis target region and every function called by the single function, the combined pointer information treating the single function as a context.

4. The data dependence analysis support device of claim 1, further comprising
an analysis target region designation unit configured to receive input of information designating the analysis target region.

5. The data dependence analysis support device of claim 1, further comprising
a region designation unit configured to receive input of information designating the two or more threaded regions.

6. The data dependence analysis support device of claim 1, further comprising
an inter-region dependence information output unit configured to output the inter-region dependence information.

7. The data dependence analysis support device of claim 1, wherein
when the pointer information generation unit stores pointer information for a same source program, the dataflow information generation unit generates the dataflow information using the stored pointer information.

8. The data dependence analysis support device of claim 1, wherein
when the dataflow analysis unit stores dataflow information for a same analysis target region, the inter-region dependence information generation unit generates the inter-region dependence information using the stored dataflow information.

9. A data dependence analysis support program for causing a computer to perform a context-sensitive data dependence analysis on a source program,
the context-sensitive data dependence analysis comprising the steps of:
generating pointer information by performing a context-sensitive pointer analysis on every pointer used in the source program;
generating dataflow information by performing a context-sensitive dataflow analysis, using the pointer information, on an analysis target region that is a portion of the source program and is designated for analysis of data dependence between two or more threaded regions; and
generating inter-region dependence information on data dependence between the two or more threaded regions using the dataflow information, the inter-region dependence information indicating a threaded region that is a source of dependence, a threaded region that is a target of dependence, and a variable causing dependence.

10. A data dependence analysis support method for performing a context-sensitive data dependence analysis on a source program, comprising the steps of:
generating pointer information by performing a context-sensitive pointer analysis on every pointer used in the source program, the pointer information indicating correspondence between each pointer and the variable pointed to by the pointer;
generating dataflow information by performing a context-sensitive dataflow analysis, using the pointer information, on an analysis target region that is a portion of the source program and is designated for analysis of data dependence between two or more threaded regions, and
generating inter-region dependence information on data dependence between the two or more threaded regions using the dataflow information, the inter-region dependence information indicating a threaded region that is a source of dependence, a threaded region that is a target of dependence, and a variable causing dependence.
